(19) United States
(12) Patent Application Publication
(10) Pub. No.: US 2009/0207196 A1
(43) Pub. Date: Aug. 20, 2009

(54) IMAGE FORMING APPARATUS AND CONTROL METHOD THEREOF

(75) Inventor: Nobuhiko Nakahara, Susono-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/032,118

(22) Filed: Feb. 15, 2008

(51) Int. Cl. H04N 1/034; B41J 29/38

(52) U.S. Cl. 347/3; 347/5

(57) ABSTRACT

An image forming apparatus according to the invention includes: a first image printing module that prints an image on a recording paper; and a second image printing module capable of printing by a paper feeding system that is serial to the first image printing module in the case of printing on a recording paper that is identical to the recording paper, and capable of printing simultaneously with and parallel to the first image printing module by a paper feeding system that is parallel to the first image printing module in the case of printing on a recording paper that is different from the recording paper. With the image forming apparatus according to the invention, highly flexible apparatus configurations and function configurations are realized and therefore the diversification in technology and diverse applications by users can be dealt with.

### BACKGROUND OF THE INVENTION

1. Technical Field of the Invention

The present invention relates to an image forming apparatus and a control method thereof, and particularly to an image forming apparatus and a control method thereof that enable realization of plural functions in one unit.

2. Related Art

Conventionally, various techniques have been proposed with respect to an image forming apparatus that uses a combination of various types of image forming systems, for example, an image forming apparatus that uses a combination of an electrophotographic system and an inkjet system.

For example, JP-A-5-22546 discloses a copy machine that is capable of forming an image with additional information added to an original and that has first image forming means for forming an image by an electrophotographic system and second image forming means using a system different from the electrophotographic system (for example, an inkjet system) that is capable of forming an image related to additional information.

Recently, multi-function apparatuses have been widely used in which various functions such as the copy function, printer function, facsimile function, scanner function and image data saving function are integrated in one apparatus. The multi-function apparatus is called MFP (multi-function peripheral). Users properly use the various functions provided by the MFP in accordance with their purposes and thus improve their business efficiency.

Meanwhile, with the progress in information processing technology, so-called electronic documents have increased. It has become common that objects to be printed include not only conventional paper documents but also a mixture of electronic documents and paper documents. This requires advanced information management technology in an image forming apparatus such as enhancement of security.

Also, users' demands with respect to the quality of printing have been diversified. Not only seeking beautiful printing but also quality and services that meet users' diverse applications are required.

Meanwhile, users' demands with respect to printing speed show a tendency toward diversification. If a higher speed is simply sought, the apparatus increases in size and price. As a result, the apparatus may be accepted only by particular users.

In this manner, with the conventional form of apparatus that realizes predetermined uniform functions in one apparatus, it is becoming difficult to sufficiently deal with the diversification in technology and diverse applications by users as described above.

### SUMMARY OF THE INVENTION

In view of the foregoing circumstances, it is an object of the present invention to provide an image forming apparatus and a control method thereof that can deal with the diversification of technology and diverse applications by users by realizing a highly flexible apparatus configuration and function configuration.

To achieve the above object, an image forming apparatus according to an aspect of the invention includes: a first image printing module that prints an image on a recording paper; and a second image printing module capable of printing by a paper feeding system that is serial to the first image printing module in the case of printing on a recording paper that is identical to the recording paper, and capable of printing simultaneously with and parallel to the first image printing module by a paper feeding system that is parallel to the first image printing module in the case of printing on a recording paper that is different from the recording paper.

Also, an image forming apparatus according to another aspect of the invention includes: a first image printing module that prints an image on a recording paper; and a second image printing module capable of printing by a paper feeding system that is serial to the first image printing module in the case of printing on a recording paper that is identical to the recording paper, and capable of printing simultaneously with and parallel to the first image printing module by a paper feeding system that is parallel to the first image printing module in the case of printing on a recording paper that is different from the recording paper; wherein the first image printing module and the second image printing module print an image by different image forming systems from each other.

A control method of an image forming apparatus according to still another aspect of the invention includes: printing an image on a recording paper by using a first image printing module; and printing by using a second printing module by a paper feeding system that is serial to the first image printing module in the case of printing on a recording paper that is identical to the recording paper by using the second printing module, and printing simultaneously with and parallel to the first image printing module by a paper feeding system that is parallel to the first image printing module in the case of printing on a recording paper that is different from the recording paper.

### BRIEF DESCRIPTION OF THE DRAWINGS

In the attached drawings,

FIG. 1 is a view showing an exemplary configuration of an image forming apparatus according to the first embodiment of the invention;

FIG. 2 is a flowchart showing an example of processing by a control method of the image forming apparatus according to the first embodiment of the invention;

FIG. 3A and FIG. 3B are views showing a carrying path (paper feeding system) of a recording paper in the image forming apparatus according to the first embodiment;

FIG. 4 is a view showing an exemplary configuration of an image forming apparatus according to the second embodiment of the invention;

FIG. 5A and FIG. 5B are views showing a carrying path (paper feeding system) of a recording paper in the image forming apparatus according to the second embodiment;

FIG. 6A to FIG. 6C are views showing an exemplary configuration of an image printing module that is attachable and removable in the image forming apparatus according to the first or second embodiment;

FIG. 7 is a view for explaining tint block printing in the image forming apparatus according to the second embodiment; and

FIG. 8 is a view for explaining watermark printing (hidden information printing) in the image forming apparatus according to the second embodiment.

### DETAILED DESCRIPTION OF THE PREFERRED EMBODIMENTS

An image forming apparatus and a control method thereof according to the invention will be described with reference to the attached drawings.

### (1) First Embodiment

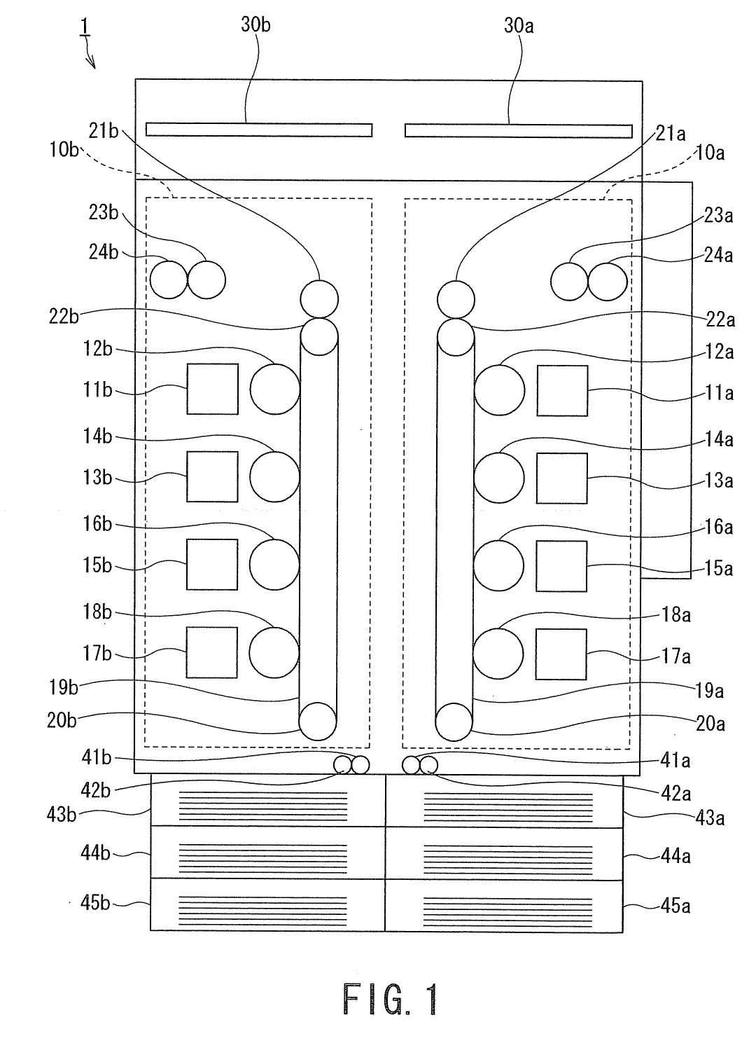

FIG. 1 is a view schematically showing an exemplary configuration of an image forming apparatus 1 according to the first embodiment. The image forming apparatus 1 is an apparatus having the function of image forming (image printing) on a recording paper, for example, a copy machine, MFP, printer or the like. FIG. 1 mainly shows an extraction of components related to image printing and does not show components related to functions other than image printing, for example, a scanner unit and an image processing unit in a copy machine.

The image forming apparatus 1 has plural image printing modules. For example, as shown in FIG. 1, the image forming apparatus has two image printing modules of a first image printing module 10a and a second image printing module lob.

Moreover, corresponding to the first image printing module 10a, the image forming apparatus has plural paper feeding trays 43a, 44a, 45a that house recording papers yet to be printed, and a paper discharge tray 30a to discharge printed recording papers.

Similarly, corresponding to the second image printing module 10b, the image forming apparatus has plural paper feeding trays 43b, 44b and 45b that house recording papers yet to be printed, and a paper discharge tray 30b to discharge printed recording papers.

In the image forming apparatus 1 according to the first embodiment, both the two image printing modules 10a, 10b use an image printing system of the same kind. FIG. 1 shows the configuration of the image printing modules, each of which uses an electrophotographic system.

The image printing modules 10a, 10b have a tandem configuration that enables color printing. The image printing modules 10a, 10b have toner modules 11a, 11b and photoconductive drums 12a, 12b corresponding to cyan (C), toner modules 13a, 13b and photoconductive drums 14a, 14b corresponding to magenta (M), toner modules 15a, 15b and photoconductive drum 16a, 16b corresponding to yellow (Y), and toner modules 17a, 17b and photoconductive drums 18a, 18b corresponding to black (K).

Each toner module has a charging unit, an exposure unit, a developing unit, a neutralizing unit and so on (none of which is shown in the drawing). These units are arranged in the circumferential direction of each photoconductive drum.

The image printing modules also have intermediate transfer belts 19a, 19b. The intermediate transfer belts 19a, 19b are configured in such a manner that they can continuously turn between driving rollers 20a, 20b and transfer rollers 22a, 22b.

Moreover, the image printing modules have transfer rollers 21a, 21b paired with the transfer rollers 22a, 22b, and also have pairs of fixing rollers 23a, 24a and 23b, 24b, respectively.

Toner images corresponding to the colors of C, M, Y and K are formed on the surface of the photoconductive drums by the toner modules. The toner images of these colors are superimposed on the intermediate transfer belts 19a, 19b in a manner of preventing occurrence of a misalignment and then intermediate-transferred. A full-color toner image is thus formed on the intermediate transfer belts 19a, 19b.

Meanwhile, the recording papers housed in the paper feeding trays (for example, the paper feeding trays 43a and 43b) are taken out by pickup rollers 41a, 42a and 41b, 42b and are guided to each nipping part between the transfer rollers 21a, 22a and between the transfer rollers 21b, 22b by a carrying mechanism, not shown.

At the nipping parts, the toner images on the intermediate transfer belts 19a, 19b are transferred to the recording papers, respectively. After that, the recording papers are carried to nipping parts between the pair of fixing rollers 23a, 24a and between the pair of fixing rollers 23b, 24b. The toner images are fixed to the recording papers by being heated and pressurized at the nipping parts.

In this manner, the image forming apparatus 1 according to the first embodiment employs the configuration in which the image printing modules 10a, 10b using the same electrophotographic system are arranged in parallel.

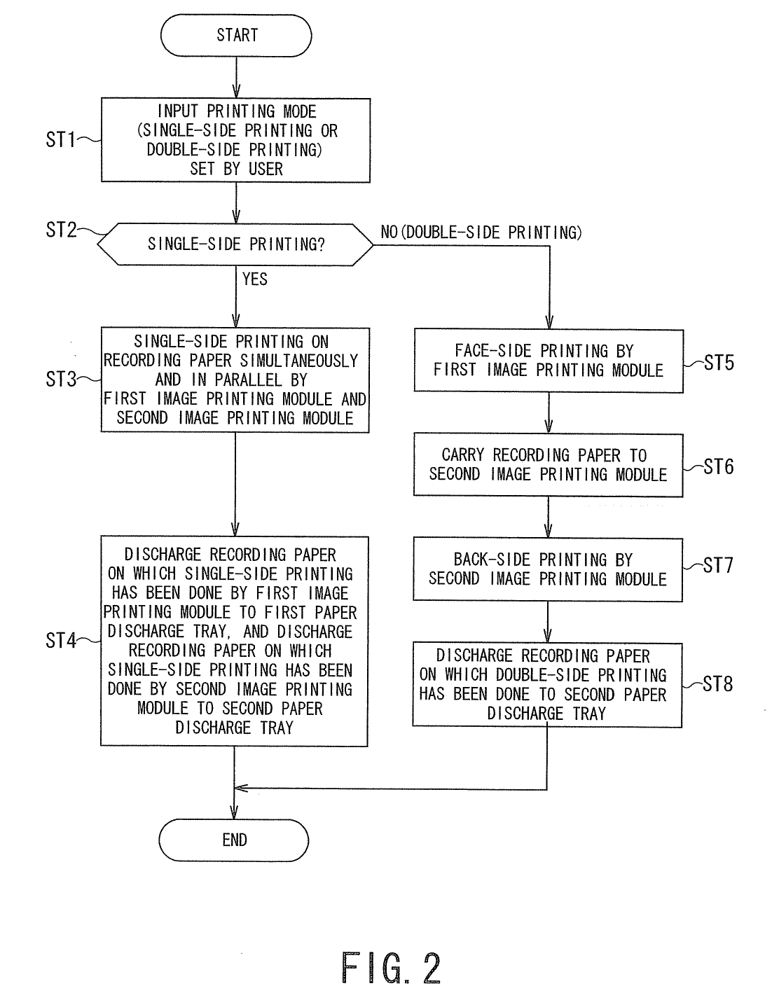

Next, a control method of the image forming apparatus 1 configured as described above will be described. FIG. 2 is a flowchart showing a control method of the image forming apparatus 1, particularly, an example of print processing by the two image printing modules 10a, 10b.

First, in step ST1, a printing mode set by a user is inputted. The printing mode is, for example, a single-side printing mode or double-side printing mode. In the case of the single-side printing mode (YES in step ST2), the processing goes to step ST3 and step ST4. On the other hand, in the case of the double-side printing mode (NO in step ST2), the processing goes to steps ST5 to ST8.

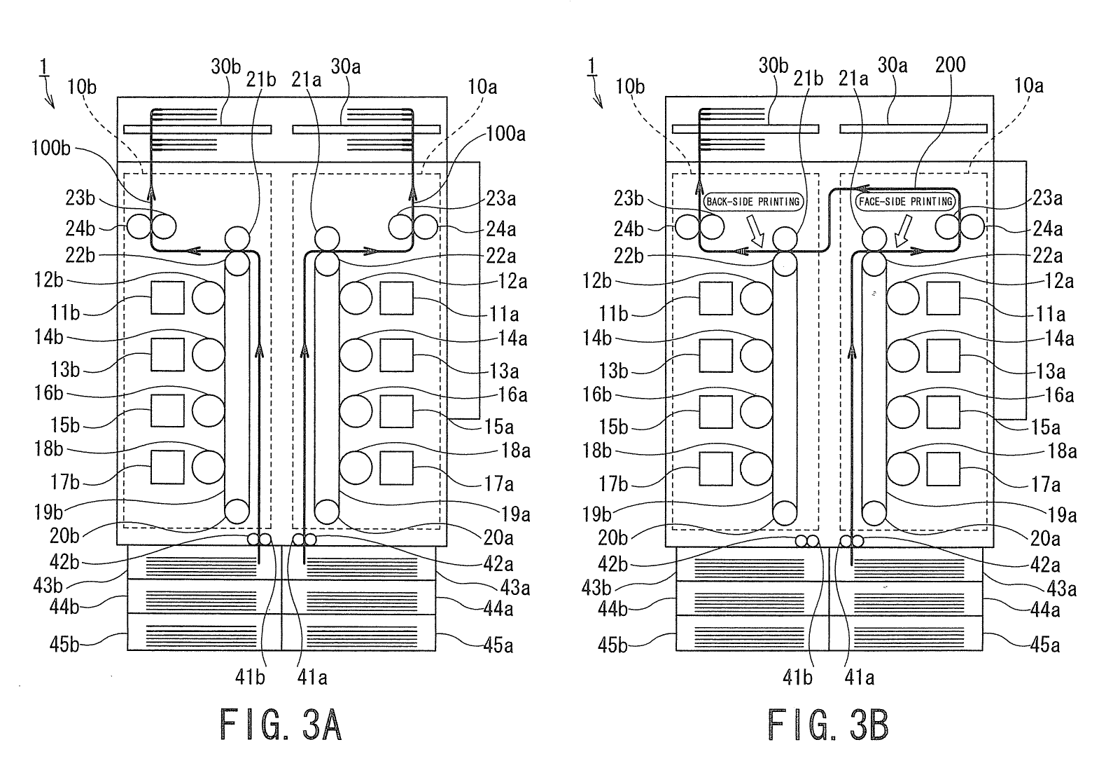

FIG. 3A is a view showing a flow of a recording paper in the case of the single-side printing mode, as indicated by bold arrows. As printing is started in the single-side printing mode, a recording paper housed in the first paper feeding tray 43a (or 44a, 45a) is taken out into the first image printing module 10a by the pickup rollers 41a, 42a, and carried in the first image printing module 10a by a first carrying path 100a. A toner image is transferred to this recording paper from the intermediate transfer belt 19a by the transfer rollers 21a, 22a and the toner image is fixed to the recording paper by the fixing rollers 23a, 24a.

Meanwhile, simultaneously with and parallel to this processing, a recording paper housed in the second paper feeding tray 43b (or 44b, 45b) is taken out into the second image printing module 10b by the pickup rollers 41b, 42b, and carried in the second image printing module 10b by a second carrying path 100b. A toner image is transferred to this recording paper from the intermediate transfer belt 19b by the transfer rollers 21b, 22b and the toner image is fixed to the recording paper by the fixing rollers 23b, 24b (step ST3).

In this manner, the recording papers on which single-side printing has been done simultaneously and in parallel by the first and second image printing modules 10a, 10b are then discharged to the first paper discharge tray 30a and the second paper discharge tray 30b, respectively (step ST4).

On the other hand, FIG. 3B is a view showing a flow of a recording paper in the case of the double-side printing mode, as indicated by bold arrows. As printing is started in the double-side printing mode, first, a recording paper housed in the first paper feeding tray 43a (or 44a, 45a) is taken out into the first image printing module 10a by the pickup rollers 41a, 42a, and carried in the first image printing module 10a by a double-side printing carrying path 200. A toner image is transferred to this recording paper from the intermediate transfer belt 19a by the transfer rollers 21a, 22a. At this time, the toner image is transferred to the face side of the recording paper. After that, the toner image is fixed to the recording paper by the fixing rollers 23a, 24a (step ST5).

The double-side printing carrying path 200 is configured to be directed from the fixing rollers 23a, 24a to the second image printing module 10b. More specifically, it is directed to the nipping part between the transfer rollers 21b, 22b in the second image printing module 10b (step ST6). At this nipping part, the toner image formed on the second intermediate transfer belt 19b is transferred to the recording paper. Since the recording paper is reversed while being carried from the first image printing module 10a to the second image printing module lob, the toner image is transferred to the back side of the recording paper at the nipping part between the transfer rollers 21b, 22b (step ST7). The toner image transferred to the back side of the recording paper is fixed by the fixing rollers 23b, 24b and the recording paper on which double-side printing has been done is discharged to the second paper discharge tray (step ST8).

With the above-described configuration of the image forming apparatus according to the first embodiment, for example, the following advantages can be obtained.

First, high-speed printing can be realized with high reliability. Normally, if high-speed printing is to be carried out with one printing route, the process speed must be raised. For example, to realize the printing speed of 60 papers per minute (ppm) in a configuration having one printing route, the process speed itself must be 60 ppm. An apparatus having the process speed of approximately 60 ppm is generally called a high-speed machine, which is technically realizable but has greater development difficulty than a medium-speed machine (an apparatus having the process speed of approximately 30 ppm) and needs to use components of higher reliability. Therefore, the acquisition cost of the high-speed machine is higher than the image forming apparatus having the process speed of approximately 30 ppm (medium-speed machine). Also, the high-speed machine generally requires a higher cost of maintenance to keep printing quality than the medium-speed machine.

On the other hand, since the image forming apparatus according to the first embodiment has the configuration in which the two image printing modules 10a, 10b are arranged in parallel and capable of printing simultaneously and in parallel, the printing speed equivalent to that of the high-speed machine (for example, 60 ppm) can be achieved as a whole while the process speed of these image printing modules 10a, 10b is kept equivalent to that of the medium-speed machine (for example, 30 ppm). That is, using the medium-speed machine technology that has relatively low development difficulty and high reliability supported by the long-term use performance, high-speed printing equivalent to the high-speed machine can be realized.

In the case of single-side printing, perfectly simultaneous parallel printing is possible, as can be seen from FIG. 3A. Also in the case of double-side printing, parallel processing by the image printing modules 10a, 10b is possible except for a part of the final processing. That is, if double-side printing at 30 ppm is to be carried out by the image printing module of one system, the image forming process at 60 ppm should be repeated twice, that is, on the face side and the back side. On the other hand, with the image forming apparatus 1 according to the first embodiment, as can be seen from FIG. 3B, the image forming processes are carried out substantially in parallel by using the two image printing modules 10a, 10b and only the processing from transfer to the back side to paper discharge is serial. Therefore, even if the process speed of each of the image printing modules 10a, 10b is 30 ppm, which is equivalent to the speed of the medium-speed machine, double-side printing can be carried out at a speed close to 30 ppm as a whole.

As described above, high-speed printing can be carried out as a whole by using the two image printing modules 10a, 10b. Moreover, various advantages can be achieved as follows.

First, since one of the two image printing modules 10a, 10b can be used as a redundant system, a total system down can be substantially eliminated. For example, if it is assumed that failure occurs in one image printing module once a month, the failure rate (per day) is 1/30. On the other hand, in the image forming apparatus 1 according to the first embodiment, the failure rate (per day) at which the two image printing modules 10a, 10b simultaneously fail (a total system down occurs) is reduced to 1/900.

Also, since the two image printing modules 10a, 10b exist, the probability of occurrence of a standby state for a print job can be reduced. For example, if it is assumed that a print job of approximately four sheets per minute occurs, the probability that one must wait during the use by another user is about 6.3% if the high-speed machine (for example, 60 ppm) has one system. On the other hand, in the case where two systems of medium-speed machines (for example, 30 ppm) are provided to print simultaneously and in parallel as in this embodiment, the probability is reduced to about 0.8%.

Moreover, the warm-up time until printing is enabled can be reduced as well. Generally, in the case of the high-speed machine, the process time of fixing and so on is shorter than in the medium-speed machine and therefore the time for the machine to reach a required temperature is longer. However, with the configuration having two systems of medium-speed machines, the warm-up time of the individual image printing modules 10a, 10b is shorter than the case of one system of high-speed machine.

In addition to the above advantages, the following advantages are achieved by configuring the image printing modules 10a, 10b as modules that are attachable to and removable from the apparatus body.

For example, when the image forming apparatus 1 is acquired for the first time, the apparatus is in the form having only one image printing module 10a loaded therein. After that, when the conditions of use of the image forming apparatus 1 change and an apparatus of higher speeds is necessary, the other image printing module 10b will be acquired and loaded. As the image printing modules 10a, 10b are thus configured to be attachable and removable, the form of the apparatus that meets the actual need of the user can be provided.

Also, an image printing module for color printing and an image printing module for monochrome printing can be suitably combined in accordance with the user's needs. FIG. 2 shows an example with a color printing configuration in which four photoconductive drums and four toner modules corresponding to the four colors of C, M, Y and K are provided in both the image printing modules 10a, lob. However, one of the image printing modules 10a, 10b can be an image printing module for monochrome printing that has one photoconductive drum for black (K) and one toner module. Also, both image printing modules 10a, 10b can be image printing modules for monochrome printing. Moreover, in the initial stage where the apparatus is acquired, both image printing modules 10a, 10b can be image printing modules for monochrome printing, and in the course of the use, one or both of them can be upgraded to an image printing module for color printing.

In this manner, in the image forming apparatus 1 according to this embodiment, the system configuration adapted to the user's diverse demands is possible.

### (2) Modifications of First Embodiment

The first modification is a form in which the two image printing modules 10a, 10b can be set at different security levels from each other. For example, one of the image printing modules is set in such a manner that printing cannot be carried out unless authentication information is inputted, and the other printing module is set in such a manner that printing can be carried out without input of authentication information.

With the recent progress in information processing technology, an image forming apparatus, for example, an MFP, having the printer function of printing from an external personal computer or the like via a network has become widely used. For the apparatus connected to the network, various security enhancement measures are major tasks. In the image forming apparatus having the printer function, it is one of the important security techniques to prevent leakage of confidential information to a third party due to failure to collect a recording paper for which printing has been remotely designated. Therefore, for example, in a security technique called private printing, a print is outputted only when the person who has remotely designated printing from a personal computer goes to the MFP or the like and inputs authentication information or the like from the control panel of the MFP. In the private printing, the security level is improved by the input of authentication information, but the operation burden on the user increases. Moreover, if the user does a wrong operation, the business efficiency may be considerably lowered to the contrary.

Thus, in the image forming apparatus 1 according to the first modification, one image printing module is set at a different security level from the other image printing module. A mechanism is provided in which the image printing module with the higher security level is used for printing whenever a confidential document or the like is to be printed, whereas an ordinary document is printed by the other image printing document. For example, as the user sets the security level of documents, the printer driver may automatically (or semi-automatically) select the image printing module with the higher security level. Alternatively, the image printing module with the higher security level may be automatically selected in accordance with the type of documents. In the case where the image printing module with the higher security level is selected, high security can be ensured since printing can be carried out only when the user has inputted authentication information. However, in the case where the other image printing module is selected, anyone can freely print ordinary documents and therefore it is convenient.

The second modification is a form in which the two image printing modules 10a, 10b can be set at different resolution levels. Recent MFPs handle images of various resolution levels. Various levels of resolutions are used depending on images to be handled, for example, FAX images for which resolution is defined by communication standards, scanner images scanned at low resolution, high-resolution images for printer, various digital camera images, copy images and so on. Generally, in the case of printing in an MFP, various data format conversions and accompanying resolution conversions are carried out within the MFP. To reduce the types and the number of times of these resolution conversions, the image forming apparatus 1 according to the second modification employs a configuration in which plural (for example, two) image printing modules having different basic resolution levels are provided and these image printing modules are switched in accordance with the functions selected in the MFP.

For example, an image printing module having the basic resolution of 400 dpi and an image printing module having the basic resolution of 600 dpi are provided. Then, the image printing module that has the resolution closer to that of the image to be printed or the resolution that can be converted more easily to that of the image to be printed (for example, resolution of integral multiple or integral fraction) is selected for carrying out printing. As a result, it is possible to carry out printing without converting resolution at all or with resolution conversion in which image quality is maintained.

Additionally, one image printing module may be selected when the FAX function is selected, whereas the other image printing module may be automatically selected when other functions are selected. Alternatively, the resolution of images is monitored and one image printing module may be selected when a high-resolution image is to be printed, whereas the other image printing module may be automatically selected when a low-resolution image is to be printed.

### (3) Second Embodiment

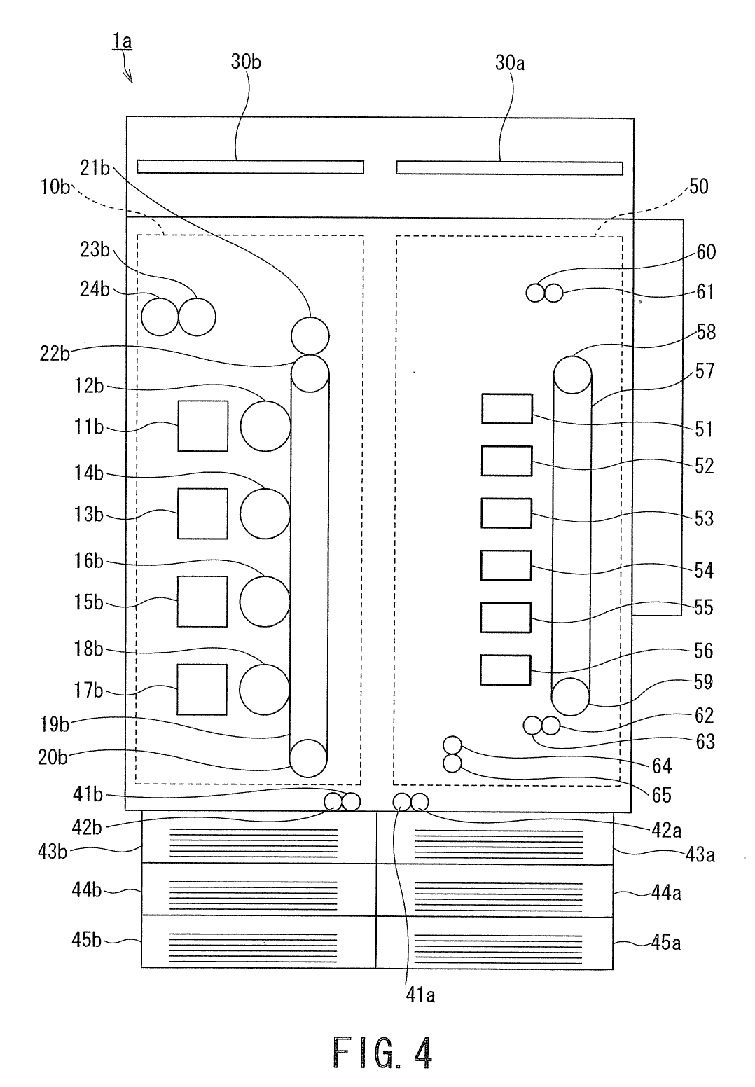

FIG. 4 is a view showing an exemplary configuration of an image forming apparatus 1a according to the second embodiment. The image forming apparatus 1a according to the second embodiment employs a form in which plural image printing modules having different image printing systems are provided. For example, the image forming apparatus 1a shown in FIG. 4 has two image printing modules of an image printing module 50 that uses an inkjet system and an image printing module 10b that uses an electrophotographic system.

Inkjet modules for four colors or more (in the example of FIG. 4, six colors) are provided in the image printing module 50 using the inkjet system. A recording paper taken out of a paper feeding tray 43a situated below the image printing module 50 is carried through a path directed from bottom to top by pairs of carrying rollers (60, 61), (62, 63) and (64, 65) and a carrying belt 57 driven by belt rollers 58, 59. While the recording paper is carried by the carrying belt 57, color images are printed with the inkjet system by the inkjet modules 51 to 56.

Meanwhile, toner modules and photoconductive drums for the basic four colors of C, M, Y and K are provided in the image printing module 10b using the electrophotographic system. Generally, the manufacturing cost increases if multicolor printing is to be carried out by using more colors than the basic four colors in the electrophotographic system. On the other hand, in the inkjet system, multicolor printing by inexpensive inkjet modules is relatively easy.

Thus, in the image forming apparatus 1a according to the second embodiment, color printing with the basic four colors of C, M, Y and K is carried out by the image printing module 10b using the electrophotographic system, and color printing containing chromatic colors other than C, M, Y and K is carried out by the image printing module 50 using the inkjet system. Chromatic colors other than C, M, Y and K are not two-color components blue, green and red that can be realized by combinations of C, M, Y and K, but are so-called spot colors that cannot be realized by a combination of C, M, Y and K, for example, corporate color, pantone, duo tone, gold, sliver and so on. With the image forming apparatus 1a according to the second embodiment, printing with spot colors that are difficult to be realized in the ordinary electrophotographic system can be realized in accordance with the user's needs.

Also, by adding and combining light cyan and light magenta as chromatic colors other than C, M, Y and K, it is possible to realize a broader range of color reproducibility exceeding the range of color reproducibility that can be realized by C, M, Y and K alone, and to print an image with less granular and smooth image quality.

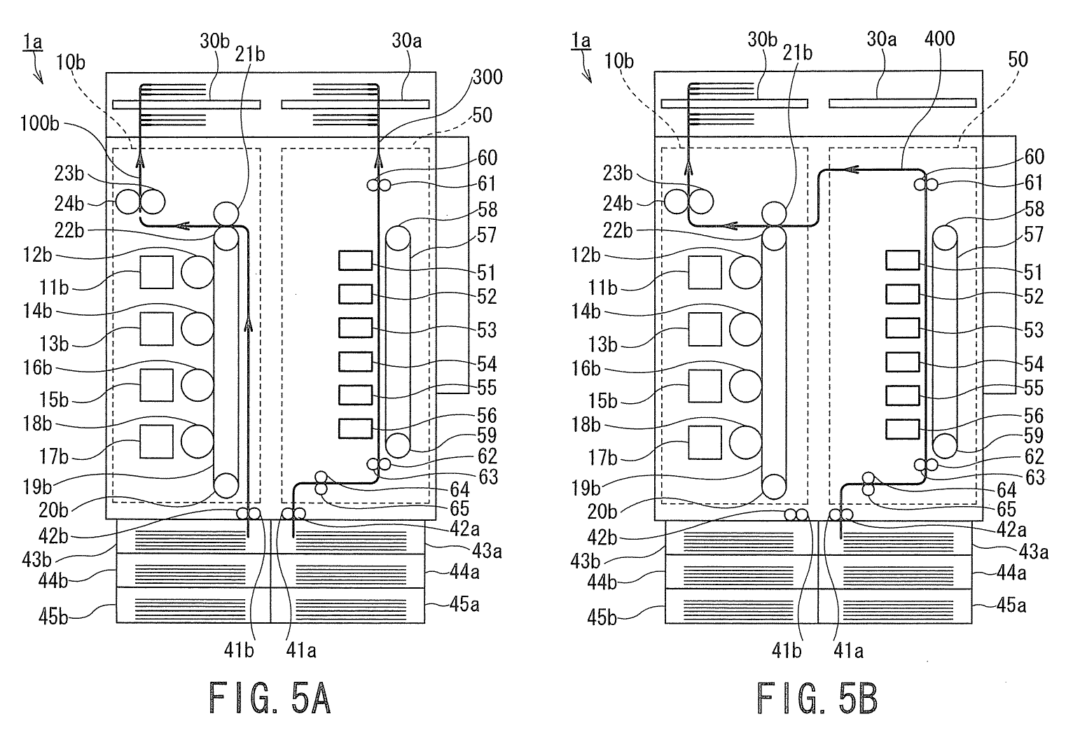

FIG. 5A and FIG. 5B show an exemplary flow of a recording paper in the image forming apparatus 1a according to the second embodiment. As in the first embodiment, the form of simultaneous parallel printing by using the image printing module 10b and the image printing module 50 (FIG. 5A) and the form of printing with the inkjet system by the image printing module 50 and then superimposing and printing a toner image on the printed side with the electrophotographic system (FIG. 5B) are shown.

### (4) Modification of Second Embodiment

Both the image printing module 10b using the electrophotographic system and the image printing module 50 using the inkjet system are configured to be attachable to and removable from the apparatus body. Their configuration can be modified in accordance with the user's needs.

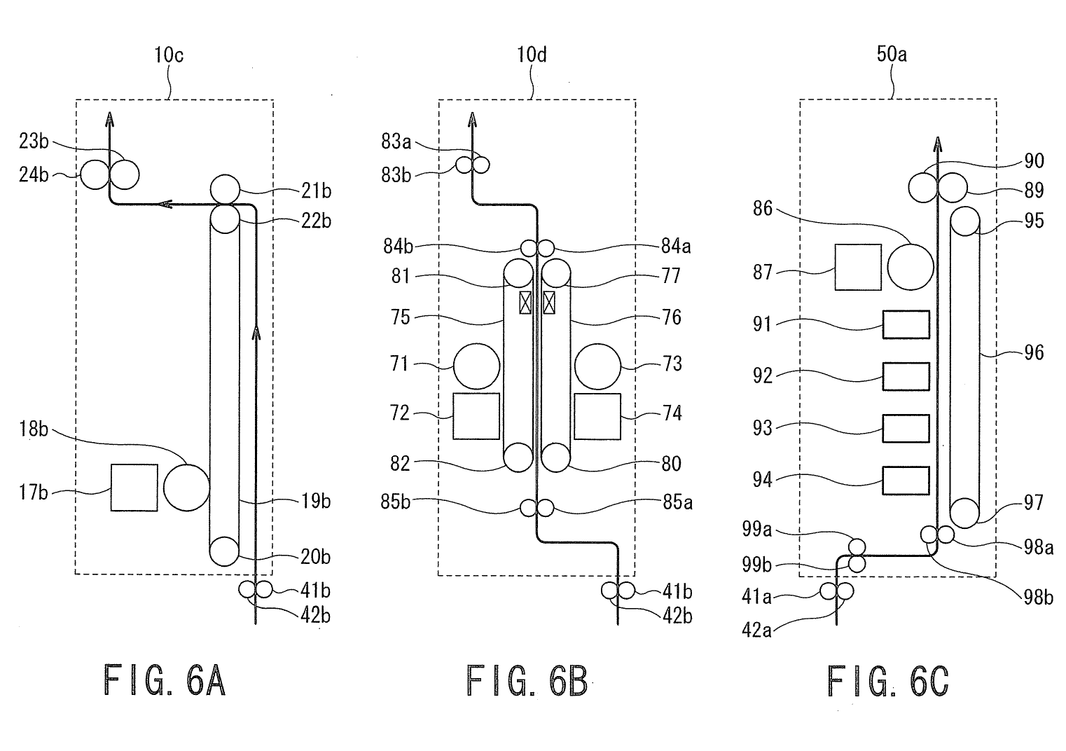

FIG. 6A shows a configuration of an image printing module 10c that prints only with black (K) using the electrophotographic system. This module is loaded, for example, instead of the image printing module 10b with the four colors of C, M, Y and K.

Generally, business models of MFPs employ different charging systems between color printing and monochrome printing. Naturally, the toner expense is higher in color printing and therefore it has significantly expensive setting. Meanwhile, a bi-color printing mode has recently been developed as a high value-added function. In this mode, one color is black and an arbitrary color can be selected for the other color. This mode is a value-added function having a user advantage that printing is carried out with two colors but charging is the same as in monochrome printing. However, though two colors are used, the process operation for all the four colors must be separately carried out because of the structure of the electrophotographic system, particularly in the case of the tandem system as in the image printing module 10b. Also, even with systems other than the tandem system, more complicated control is necessary than in the case of single color. Therefore, the exhaustion of mechanical components and the consequent failure rate are less advantageous than in single-color printing. Thus, in the form employing the image printing module 10c as a modification of the second embodiment, black printing in bi-color printing is carried out by the image printing module 10c using the electrophotographic system, and other colors are printed by the image printing module 50 using the inkjet system. Thus, bi-color printing can be realized at a low cost without using the expensive color process of electrophotography.

FIG. 6B is a view showing an exemplary configuration of an image printing module 10d capable of black double-side printing by using the electrophotographic system. As this image printing module 10d is loaded in the apparatus body, black double-side printing and color printing by the inkjet system can be carried out simultaneously and in parallel. Also, color printing by the inkjet system can be superimposed on one side where black double-side printing has been done.

FIG. 6C is a view showing a configuration of an image printing module 50a capable of carrying out color printing by the inkjet system and black printing by the electrophotographic system in one carrying path for recording paper. As the image printing module 50a is loaded, inexpensive bi-color printing can be carried out by one image printing module.

### (5) Other Modifications of Second Embodiment

As printing by the inkjet system and printing by the electrophotographic system are superimposed on the same side, special printing other than those described above can be realized.

For example, there is a technique of tint block printing as a security printing technique. With this technique, different patterns with approximately the same density are recorded on a normal original. These patterns, which look visually uniform, are separated into remaining dots and disappearing dots when copied, and the information of the disappearing dots appears. This technique of tint block printing is based on a simple principle but can actually be realized with substantial difficulty. This is because the image scanning device has characteristic differences and individual differences depending on the type of copy machine and there is also a difference in the image processing method or image processing parameter. Moreover, difference in foundation adjustment for each machine type and even slight difference in image processing for each copy mode are factors contributing to the difficulty. If the density of the tint block pattern is increased excessively in order to avoid these, it becomes visually unpleasant and the consumption cost of toner and ink cannot be ignored.

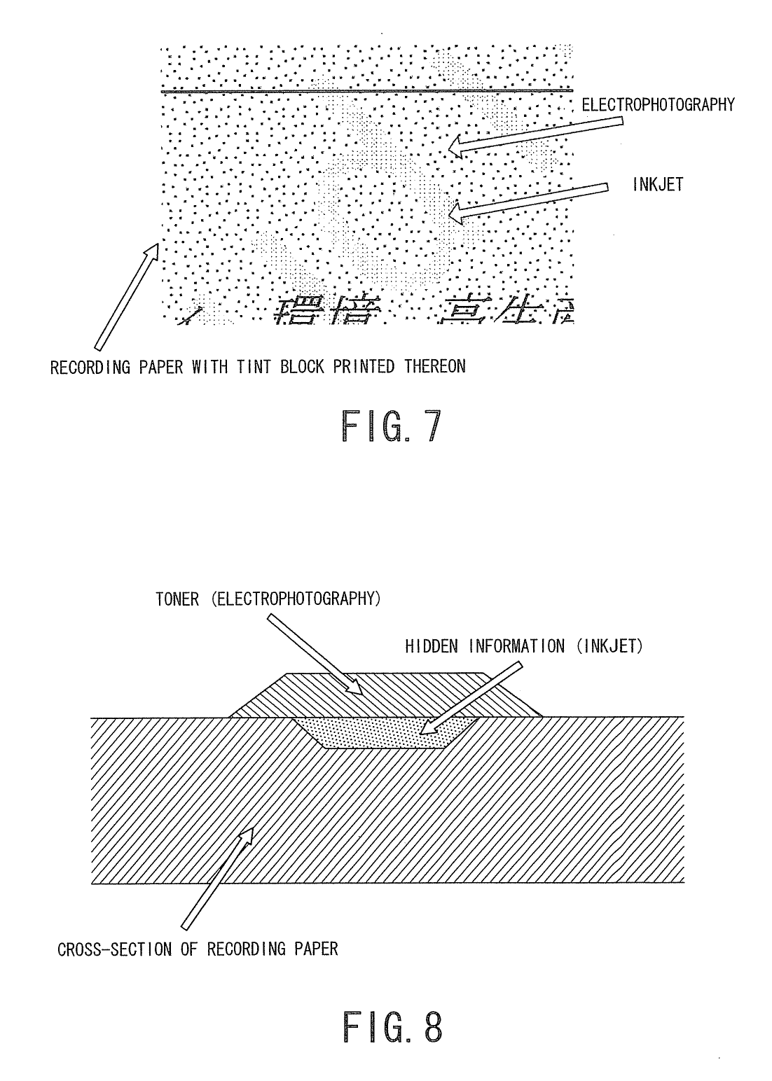

Thus, in the modification of the image forming apparatus 1a according to the second embodiment, the remaining dots (rough dots) are printed by the image processing module using the electrophotographic system, and the disappearing dots (dense dots) are printed by the image printing module using the inkjet system, as shown in FIG. 7. As a result, it is possible to easily discriminate the patterns of the remaining dots and the disappearing dots when scanned. Also, since both patterns can be formed in a lighter state, waste of toner and ink due to increase in the pattern density can be prevented. With the current technology, the inkjet system can reproduce micro dots more stably. Therefore, the disappearing dots are printed by the inkjet system. Blurring of ink may occur depending on the type of recording paper. Therefore, in such cases, a technique of applying a surface coating material for ink to the recording paper may be taken.

Also, there is a technique of watermark printing (or hidden information printing) as another security printing technique.

FIG. 8 shows a sectional view of a recording paper in order to explain watermark printing (or hidden information printing).

In accordance with the general printing principle, a toner image is formed on the surface of a recording paper with a toner as a color material of the electrophotographic system, and in the inkjet system, ink infiltrates into the recording paper to form an ink image, as shown in FIG. 8. Using this principle, hidden information is printed by the image printing module using the inkjet system and thus an ink image is formed within the recording paper, and a toner image of a normal image is formed thereon by the image printing module using the electrophotographic system. Thus, with the toner image covering all or a part of the ink image, which is the confidential information, the ink image can be prevented from being visually recognized.

To read out the hidden information, a device having a light source that can detect ink components can be used and the information that cannot be visually identified with an ordinary light source can be recognized relatively easily. At this time, even if the ink image has a large area and is spreading out of the toner image, it does not matter unless there is any practical problem such as complete failure to read the information.

Up to this point, the combination of the electrophotographic systems and the combination of the electrophotographic system and the inkjet system have been described. However, the printing system to be used is not limited to these printing systems. For example, a system combined with an image printing module using a thermal transfer system may be used. Also, the number of image printing modules to be combined is not limited to the above-described two. Three or more image printing modules may be combined.

As described above, with the image forming apparatus and the control method thereof according to the above embodiments and their modifications, highly flexible apparatus configurations and function configurations are realized and therefore the diversification of technology and diverse applications by users can be dealt with.

The invention is not limited to the above embodiments. Practically, their components can be modified and specified without departing from the scope of the invention. Also, by proper combinations of plural components disclosed in the above embodiments, various embodiments of the invention can be formed. For example, some of the components disclosed in the embodiments may be deleted. Moreover, components of different embodiments may be properly combined.

What is claimed is:

1. An image forming apparatus comprising:
a first image printing module that prints an image on a recording paper; and
a second image printing module capable of printing by a paper feeding system that is serial to the first image printing module in the case of printing on a recording paper that is identical to the recording paper, and capable of printing simultaneously with and parallel to the first image printing module by a paper feeding system that is parallel to the first image printing module in the case of printing on a recording paper that is different from the recording paper.

2. The image forming apparatus according to claim 1, wherein both the first and second image printing modules are image printing modules using an electrophotographic system.

3. The image forming apparatus according to claim 2, wherein one of the first and second image printing modules is a color image printing module and the other is a monochrome image printing module.

4. The image forming apparatus according to claim 1, wherein in the case of printing by the serial paper feeding system, double-side printing on the recording paper is possible.

5. The image forming apparatus according to claim 1, wherein at least one of the first image printing module and the second image printing module is configured to be attachable and removable.

6. The image forming apparatus according to claim 1, wherein the first image printing module and the second image printing module are set at different security levels from each other.

7. The image forming apparatus according to claim 6, wherein one of the different security levels is a security level at which authentication for printing is required and the other is a security level at which authentication for printing is not required.

8. The image forming apparatus according to claim 1, wherein basic resolution of the first image printing module and basic resolution of the second image printing module are different from each other.

9. The image forming apparatus according to claim 1, comprising plural selectable functions having different printing resolution levels,
wherein the first image printing module and the second image printing module are switched in accordance with the functions that are selected.

10. An image forming apparatus comprising:
a first image printing module that prints an image on a recording paper; and
a second image printing module capable of printing by a paper feeding system that is serial to the first image printing module in the case of printing on a recording paper that is identical to the recording paper, and capable of printing simultaneously with and parallel to the first image printing module by a paper feeding system that is parallel to the first image printing module in the case of printing on a recording paper that is different from the recording paper;
wherein the first image printing module and the second image printing module print an image by different image forming systems from each other.

11. The image forming apparatus according to claim 10, wherein the first image printing module is an image printing module using an electrophotographic system, and the second image printing module is an image printing module using an inkjet system.

12. The image forming apparatus according to claim 11, wherein the first image printing module is an image printing module using an electrophotographic system that uses four colors of cyan, magenta, yellow, and black, and
the second image printing module is an image printing module using an inkjet system capable of printing by using a chromatic color that is different from the four colors.

13. The image forming apparatus according to claim 11, wherein the first image printing module is an image printing module using an electrophotographic system that uses four colors of cyan, magenta, yellow, and black, and
the second image printing module is an image printing module using an inkjet system capable of printing with a non-standard spot color.

14. The image forming apparatus according to claim 11, wherein the second image printing module is capable of printing to form a tint block on the recording paper.

15. The image forming apparatus according to claim 11, wherein the second image printing module is capable of printing by using an ink that is visually recognizable with a special light source.

16. The image forming apparatus according to claim 10, wherein the first image printing module and the second image printing module are set at different security levels from each other.

17. The image forming apparatus according to claim 10, wherein basic resolution of the first image printing module and basic resolution of the second image printing module are different from each other.

18. A control method of an image forming apparatus comprising:
printing an image on a recording paper by using a first image printing module; and
printing by using a second printing module by a paper feeding system that is serial to the first image printing module in the case of printing on a recording paper that is identical to the recording paper by using the second printing module, and printing simultaneously with and parallel to the first image printing module by a paper feeding system that is parallel to the first image printing module in the case of printing on a recording paper that is different from the recording paper.

19. The control method of the image forming apparatus according to claim 18, wherein both the first and second image printing modules are image printing modules using an electrophotographic system, and in the case of printing by the serial paper feeding system, double-side printing is carried out on the recording paper.

20. The control method of the image forming apparatus according to claim 18, wherein the first image printing module is an image printing module using an electrophotographic system and second image printing module is an image printing module using an inkjet system.
